(19) United States
(12) Patent Application Publication
(10) Pub. No.: US 2010/0018591 A1
(43) Pub. Date: Jan. 28, 2010

(54) FASTENING ARRANGEMENT FOR A GAS TANK OF A MOTOR VEHICLE

(75) Inventor: Andreas Jauss, Westernohe (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/303,360

(22) PCT Filed: May 30, 2007
(86) PCT No.: PCT/EP2007/004785

§ 371 Date: Jul. 15, 2009

(30) Foreign Application Priority Data
Jun. 3, 2006 (DE) 10 2006 026 118.6

(51) Int. Cl. B60K 15/07; F16K 27/12

(52) U.S. Cl. 137/376; 137/382

(57) ABSTRACT

A fastening arrangement for a gas tank (1) of a motor vehicle comprises: at least one gas tank for storing gaseous fuel; a valve, which is arranged on a section of the gas tank (1) which is provided with an opening, for filling and emptying the gas tank with gaseous fuel, which valve comprises a valve body (7) having control elements for controlling the valve function and connecting pieces for connecting to gaseous fuel lines; and a protective element, which is arranged on that side of the valve body (7) which faces away from the gas tank and at least partially covers the valve body (7), for protecting the valve body (7) from a mechanical introduction of force, wherein the support element serves as a tank fastening section (5) for fastening the gas tank (1) to the vehicle.

The present invention involves the technical area of motor vehicle engineering, and relates to an attachment device for a gas tank of a motor vehicle that can be operated with gas fuel.

Against the backdrop of dwindling petroleum reserves and tougher requirements on exhaust emissions, modern motor vehicles are increasingly being equipped with combustion engines that operate based on the four-stroke principle, which can be operated as bivalent motor vehicles with either liquid fuel (benzene) or gas fuel.

The gas fuels used are primarily petroleum-based liquid gases stored in gas tanks in liquid form, such as automobile gas (LPG=liquefied petroleum gas), and gas fuels stored in gas tanks in gaseous form, such as natural gas (CNG=compressed natural gas). Automobile gas essentially consists of propane and butane, and arises as a byproduct of hydrating processes during petroleum refining, while natural gas consists primarily of methane, and is obtained through extraction from natural gas sources. Since gas fuels contain no sulfur and lead compounds, and also exhibit very good combustion properties, contaminant emissions of CO, HC, NOₓ and CO₂ are lower than for engines operated exclusively with liquid fuel.

Motor vehicles that can be operated with gas fuel are provided with a gas tank comprised of potentially several containers interconnected so as to carry fluid, in which the gas fuel is stored in compressed form. For example, CNG is stored in a gas tank under a pressure of 200-300 bar.

In a gas fuel-operated motor vehicle, the gas tank is typically secured to the vehicle chassis, for example to the frame side rails, mostly in a position transverse to the traveling direction of the motor vehicle. The gas tank is usually also secured in a recess of the motor vehicle trunk. Restraining straps attached to the motor vehicle and stretched over the gas tank are among the means used for mounting the gas tank.

In addition, an end section of the gas tank that incorporates an opening is provided with an electromagnetically activatable gas valve, with which a stream of bi-directional gas fuel can be controlled to fill the gas tank and supply gas fuel to the combustion engine. Simple gas valves for controlling the gas stream are here given a conventional T shape, for example, such as those also known from diving tanks. Such gas valves are screwed into an opening in the gas tank provided with an internal thread by way of a valve body provided with an external thread, which is furnished with controllers for controlling the gas stream, along with couplings for connecting fuel lines and any needed safety devices.

Such a gas valve of the gas tank must now satisfy specific safety standards, so as to avoid damage to the gas valve and uncontrolled release of gas fuel in particular during a collision (“crash case”) of the vehicle, which necessitates special safety precautions.

For example, German Laid-Open Patent Specification DE 10308676 A1 describes a protective cap for the steel cylinder valve of a gas cylinder for gas fuel. This protective cap consists of several parts, namely a support ring for mounting a protective jacket, the protective jacket itself, and a cover for sealing the protective cap. The protective jacket is provided with openings providing free access to couplings and safety devices of the gas valve, such as a manual shutoff valve. For mounting purposes, the protective cap is secured to the neck of the gas cylinder by means of a clamping ring, for example, since production considerations dictate that the neck of the gas cylinder have relatively thick walls, and can absorb relatively high axial compressive forces in a crash case.

In order to increase the safety of the gas valve in case of a crash, it is further known to incorporate the components of the gas tank of relevance in terms of safety inside the protective container contour of the gas tank, which in this regard is especially advantageous, since the container wall of the gas tank is made out of pressure-resistant material, such as steel or carbon fiber, and consequently provides especially good protection in case of a crash.

For example, German Laid-Open Patent Specification DE 19745732 A1 describes a gas storage system with a gas cylinder and shutoff devices, in which a casing that integrates the safety-relevant components of the gas storage system is screwed into an opening of a gas cylinder. In addition, a crash protection plate is provided on the upper side of the valve body, since it is also necessary here to protect components vulnerable to crashes outside the container contour.

Such an “inner valve” is also described in German Laid-Open Patent Specification DE 10361781 A1, for example.

One significant advantage to inner valves in particular is that the simple contour of the valve sections of the valve protection located outside the gas tank can be given a simpler and more cost-effective design.

The disadvantage to the gas tank systems previously used in practice as described by example at the outset lie in particular in the fact that relatively numerous components are required to secure the gas tank to the motor vehicle and for the necessary valve protection structures, such as protective crash plates, and these require a comparatively high time outlay for assembly, while being associated with high component and production costs.

By contrast, the object of the present invention is to indicate a gas tank system that makes do with fewer components, and results in lower material and production costs than conventional gas tank systems.

This object is achieved as proposed in the invention by means of an attachment device for a gas tank of a motor vehicle having the features in the independent claim. The features in the subclaims indicate advantageous embodiments of the invention.

Shown in the invention is an attachment device for a gas tank of a motor vehicle, which encompasses a gas fuel tank for storing gas fuel, and at least one mount connected with the vehicle and gas fuel tank for securing the gas tank to the vehicle. The mount is advantageously secured to the vehicle chassis, for example to the frame side rails, and in particular allows the gas fuel tank to be positioned transverse to the traveling direction of the vehicle.

The mount for attaching the gas fuel tank to the vehicle encompasses a motor vehicle attachment section for attachment to the vehicle, and a tank attachment section for attachment to the gas tank.

In addition, the gas fuel tank is referred to only as “gas tank” for easier reference, without this precluding a filling with liquid gas, such as LPG. Basically, the term “gas fuel” also implies liquid gases here and further on.

The gas tank is designed as an accumulator, and suitable for holding compressed gas fuel, such as LPG or CNG, under a high pressure, for example of 200-300 bar, to which end it consists of a pressure-resistant material like steel or carbon fibers. The gas tank can further be composed of several containers that are interconnected in terms of flow. For example, the gas tank can be a cylindrical bottle with at least one opening arranged on at least one section.

One gas valve for filling or removing gas fuel into/from the gas tank is arranged at a section of the gas tank provided with an opening. The gas valve encompasses a valve body with control elements for controlling the valve function of the gas valve, as well as at least one coupling for connecting a gas line. Two couplings are typically provided, namely a coupling with check valve, which is used to fill the gas tank with gas fuel, and another coupling without a check valve, which is used during operation to release to the combustion engine during vehicle operation.

In addition to the control elements for controlling the valve function of the valve, the valve body is usually provided with additional elements, such as a manual shutoff valve, which makes it possible to manually interrupt the gas fuel flow via the gas valve independently of its control status.

In addition, the valve body can incorporate safety elements that ensure the operational safety of the valve. Such safety elements can include overpressure protection, e.g., in the form of a baffle plate, with which gas fuel can be released from the gas tank in a controlled manner if the gas tank overheats, such as in cases of a vehicle fire. They can further be a thermal safeguard, for example designed as a liquid-filled glass body, which bursts given excessive heating of the outer skin of the gas tank, thereby punching a hole in the wall of the gas tank through which gas fuel can escape, so as to prevent the gas tank from exploding.

Also provided is at least one protective element, for example in the form of a protective crash plate, which is situated on the side of the valve facing away from the gas tank, covers the valve at least partially, and protects against exposure to mechanical forces. The protective element is preferably designed in such a way as to completely cover the valve, in particular the valve body, and the couplings for connecting gas lines. It is especially advantageous for the protective element to cover the valve with a certain overlap.

The protective element is preferably made of a harder material than the valve. In particular, the protective element can consist of the same material as the gas tank, for example steel or carbon fibers.

The attachment device for a gas tank of a motor vehicle according to the invention is here significantly characterized in that the protective element is used as a tank attachment section, and hence as part of the mount for securing the gas tank to the vehicle. As a result, the protective element makes it possible to easily secure the gas tank to the mount connected with the vehicle.

The attachment device according to the invention advantageously economizes on components in comparison to conventional gas tank systems, enabling a savings in material and production costs, since the protective element has a dual function, specifically a protective function for protecting the underlying gas valve structures, while also functioning as part of the mount for securing the gas tank to the vehicle.

The protective element is here preferably coupled with the gas valve for filling or evacuating the gas tank, especially advantageously with the valve body of the gas valve. An attachment of the protective element to the valve body that is particularly simple in terms of production can be realized by means of a positive connection between the two, which can be designed in such a way that the section of the valve body used for joining with the protective element is a polygonal structure, e.g., square or hexagonal, while a correspondingly complementary key form is molded to the protective element for positive connection with the valve body. In like manner, however, the protective element can also be non-positively connected with the valve body, for example through bonding or screwing.

In addition, a layer consisting of an elastically dampening material can be arranged between the protective element and valve body in order to dampen mechanical impacts on the protective element.

In an advantageous embodiment of the attachment device according to the invention, the protective element is provided with a support or support elements, which can be designed as support braces, for example. The support is here used to abut the protective element against the outer skin of the gas tank, at least after the protective element has approached the gas tank, so as to in this way divert the mechanical compressive forces acting on the protective element in case of a crash to the especially stable wall of the gas tank. The support can rest against the outer wall or be spaced apart from it.

In another advantageous embodiment of the attachment device according to the invention, the mount is designed as an angle bracket, wherein a leg of the angle bracket is used as a tank attachment section for securing the mount to the gas tank or gas valve, and the other leg of the angle bracket is sued as a vehicle attachment section for securing the mount to the vehicle. The angle bracket can consist of one or two pieces. Such a mount in the form of an angle bracket enables a particularly easy and rapid mounting of the gas tank to the vehicle, in particular to the frame side rails.

In another advantageous embodiment of the attachment device according to the invention, the tank attachment section and vehicle attachment section exhibit a differing elasticity (stiffness), wherein it is especially advantageous if the tank attachment section is stiffer than the vehicle attachment section, so as to in this way be able to prevent damaging bending moments of the mount from impacting the gas valve, thereby affording additional protection to the gas valve in case of a crash.

In another advantageous embodiment of the attachment device according to the invention, the valve is designed as an inner valve with a valve body incorporated at least partially inside the gas tank, the advantage to which is that protective elements for protecting sections of the valve body located outside the gas tank can be given an especially simple design with the couplings. In this case, it is advantageous if the mount is connected with a valve body section projecting out of the gas tank.

To additional secure the gas tank to the vehicle, the gas tank can be attached by means of restraining straps connected with the vehicle.

However, the gas tank is advantageously suspended on two opposite sides of the gas tank, wherein the same mounts as described above are used on both sides. For example, this can be realized by arranging a dummy structure for the valve body in an opening of the gas tank used only for securing the accompanying mount and performs no valve function otherwise on the side opposite the side of the gas tank provided with the gas valve. For example, a dummy structure with a polygonal structure molded thereto can be screwed into an opening of the gas tank on this side, serving to form a positive connection with the accompanying mount. The dummy structure can also be provided with safety devices, such as thermal fuses.

The invention further extends to a mount of an attachment device according to the invention as described above for securing a gas tank to a motor vehicle that can operate with a gas fuel.

In addition, the invention extends to a motor vehicle equipped with at least one such mount, or with an attachment device according to the invention as described above.

The invention will now be described in greater detail based on an exemplary embodiment, wherein reference is made to the attached drawing. Shown on:

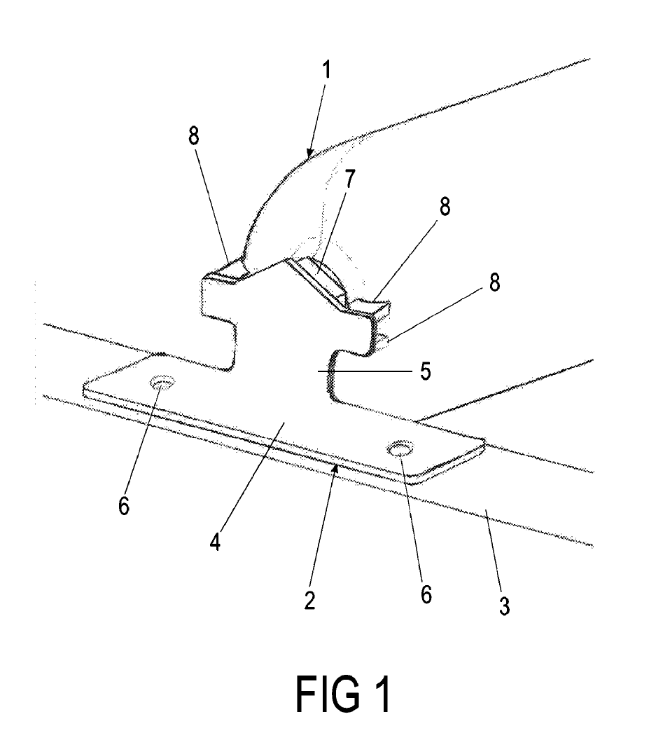

FIG. 1 is a schematic perspective view of an exemplary embodiment of the attachment device according to the invention for securing a gas tank to a motor vehicle.

According to the above, a preferred exemplary embodiment of the attachment device for a gas tank of a motor vehicle that operates with gas fuel according to the invention encompasses a gas tank labeled 1 and shown only in partially schematic form here, which is formed in a cylindrical mold. The gas tank 1 is provided with an opening for accommodating a gas valve to control the flow of gas fuel into the gas tank and out of the gas tank. The gas valve is designed as an inner valve, in which the valve body with its controllers for controlling the gas valves along with other elements, such as a manual shutoff valve and various safety devices, are mostly incorporated inside the gas container 1.

To this end, the valve body is provided with an external thread, which is screwed into the opening in the gas tank 1 provided with an internal thread. The gas valve shown on FIG. 1 only reveals an end section 7 of the valve body (“valve body head”) that protrudes out of the gas tank, and has a polygonal structure molded thereto, here a hexagon. Also not visible on FIG. 1 are two couplings radially arranged on the valve body head for connecting gas lines through which the gas tank 1 can be filled and gas fuel can be routed to the combustion engine during operation of the motor vehicle.

The valve-side end section of the gas tank 1 is secured to the vehicle chassis of the motor vehicle, in particular to a frame side rail 3, by means of a mount, which is labeled with reference number 2 in its entirety.

The mount 2 consists of a vehicle attachment section 4 used to secure it to the vehicle and a tank attachment section 5 to secure it to the gas tank 1. The vehicle attachment section 4 and tank attachment section 5 together form a one-piece angle bracket, wherein the vehicle attachment section 4 and tank attachment section 5 are arranged at a right angle relative to each other, for example. The vehicle attachment section 4 is secured to the frame side rail 3 of the vehicle chassis by means of attachment means 6, such as screws, rivets or welds. The tank attachment section is connected with the polygonal structure 7 of the valve body by means of a positive bond. To this end, the tank attachment segment 5 must be provided with a structure complementary to the polygonal structure 7, which is not shown in any greater detail on FIG. 1.

The tank attachment section 5 is roughly T-shaped, so as to cover and slightly overlap the valve body head 7 protruding out of the gas tank 1, as well as the two couplings attached thereto in a radial direction for connecting gas lines. In this regard, the tank attachment section 5 serves as a protective crash plate to protect the underlying gas valve structures in case of a crash.

In the area of the couplings arranged radially on the valve body, the tank attachment section 5 additionally has molded to it support braces 8, which extend parallel to the central longitudinal axis of the cylindrical gas tank 1 in the direction of the outer skin of the gas tank 1, and are spaced apart from the outer skin of the gas tank 1. These are used to divert the mechanical forces acting on the tank attachment section 5 or protective crash plate in case of a crash to the outer skin of the gas tank 1, and protect the gas valve structures under the protective crash plate, in particular the couplings.

The tank attachment section 5 or protective crash plate is made out of the same material as the gas tank 1, for example steel, and is harder than the valve body of the gas valve, which is usually made out of brass. In addition, the tank attachment section 5 or protective crash plate exhibits a greater stiffness than the vehicle attachment section, which given an identical material used for manufacturing the tank attachment section 5 and vehicle attachment section 4 can be achieved in particular by a greater material thickness, so that undesired bending moments of the tank attachment section 5 can be avoided. The stiffness levels of the tank attachment section 5 and vehicle attachment section 4 must here be designed in such a way as to safely absorb all dynamic horizontal and vertical vehicle accelerations.

At the end section of the gas tank 1 lying opposite the gas valve and not shown on FIG. 1, the gas tank 1 is secured by means of a mount in the form of an angle bracket as depicted on FIG. 1 to the frame side rail located on this side of the vehicle. To this end, the gas tank 1 is provided on this end section with an opening into which a dummy structure is screwed in the form of a valve body without valve function. Molded to the dummy structure is a polygonal structure with which the mount is positively connected. In the exemplary embodiment shown on FIG. 1, the gas tank 1 is hence only held at its two opposing end sections by means of mounts secured to the frame side rails or other suitable attachment points.

In the process of suspending the gas tank 1 by means of the mounts according to the invention at the two frame side rails or other suitable suspension points on the motor vehicle, the gas tank is secured to the motor vehicle in a simpler, operationally more reliable manner using protective elements in the form of protective crash plates. This makes it possible to advantageously economize on components, and hence save on material and production costs. In addition, the gas tank suspension enables a reliable handling of encountered gas-specific conditions, such as filling the gas tank during cooling or heating, as well as a diameter variation of the gas tank owing to various internal pressures while filling or evacuating.

### REFERENCE LIST

1 Gas tank
2 Mount
3 Frame side rail
4 Vehicle attachment section
5 Tank attachment section
6 Attachment means
7 Valve body polygonal structure
8 Support brace

1. An attachment device of a gas tank of a motor vehicle, comprising
at least one gas tank for storing gas fuel;
a valve arranged on the section of the gas tank (1) provided with an opening for filling or removing gas fuel into/from the gas tank, which encompasses a valve body with control elements for controlling the valve function, as well as at least one coupling for connecting a gas fuel line;
a protective element (5) that is situated on the side of the valve facing away from the gas tank, covers the valve at least partially, and protects against exposure of the valve body to mechanical forces;
at least one mount (2) connected with the vehicle and gas tank for securing the gas tank to the vehicle, which encompasses a vehicle attachment section (4) used for attachment to the vehicle, and a tank attachment section (5) for attachment to the gas tank;
characterized in that the protective element serves as a tank attachment section for attaching the gas tank to the vehicle.

2. The attachment device according to claim 1, characterized in that a protective element is connected with the valve.

3. The attachment device according to claim 2, characterized in that the protective element is connected with the valve body.

4. The attachment device according to one of claims 2 or 3, characterized in that the protective element is positively connected with the valve body.

5. The attachment device according to claim 4, characterized in that the section of the valve body used for connection with the protective element is designed as a polygonal structure (7), for example as a square or hexagon, and a corresponding complementary key form is molded to the protective element for positive connection with the valve body.

6. The attachment device according to one of claims 2 to 5, characterized in that the protective element (5) is non-positively connected with the valve body.

7. The attachment device according to one of claims 1 to 6, characterized in that the protective element (5) is provided with a support or support elements (8) for diverting mechanical forces acting on the protective element to the outer skin of the gas tank (1), wherein the support abuts the outer skin of the gas tank or is spaced apart from it.

8. The attachment device according to one of claims 1 to 7, characterized in that the mount (2) is designed as an angle bracket, wherein one leg of the angle bracket serves as a gas tank attachment section, and the other leg of the angle bracket serves as the vehicle attachment section.

9. The attachment device according to one of claims 2 to 9, characterized in that the tank attachment section and the vehicle attachment section exhibit a differing stiffness.

10. The attachment device according to claim 9, characterized in that the tank attachment section has a greater stiffness than the vehicle attachment section.

11. The attachment device according to one of claims 1 to 10, characterized in that the valve is an inner valve with a valve body incorporated at least partially inside the gas tank.

12. The attachment device according to claim 11, characterized in that the mount is connected with a valve body section protruding from the gas tank.

13. The attachment device according to one of claims 1 to 12, characterized in that similar mounts for the gas tank are arranged on mutually opposing sides of the gas tank.

14. The attachment device according to claim 13, characterized in that a dummy structure for the valve body is arranged on the side of the gas tank opposite the gas valve for attaching the accompanying mount to the gas tank.

15. A mount for an attachment device according to one of claims 1 to 14.

16. A vehicle, in particular motor vehicle, with an attachment device according to one of claims 1 to 14.
